(19) United States
(12) Patent Application Publication
(10) Pub. No.: US 2003/0191642 A1
(43) Pub. Date: Oct. 9, 2003

(54) Method for speech control of an electrical device

(76) Inventor: Dietmar Wannke, Reutlingen (DE)

Correspondence Address: STRIKER, STRIKER & STENBY, 103 East Neck Road, Huntington, NY, 11743, US

(21) Appl. No.: 09/814,420

(22) Filed: Mar. 21, 2001

(30) Foreign Application Priority Data
Mar. 21, 2000 (DE) 100 13 879.9

(51) Int. Cl. G10L 15/26

(52) U.S. Cl. 704/235; 704/200

(57) ABSTRACT

A method for speech control of an electrical device includes acoustically inputting information by spelling in an electrical device, and outputting by the electrical device a recognized character or a recognized symbol or a recognized character- or symbol sequence for acknowledgment of the character- or symbol input.

### BACKGROUND OF THE INVENTION

The present invention relates to a method for a speech control of an electrical device, wherein informations to be inputted are inputted by spelling.

Electrical devices in form of vehicle navigation devices are known, in which information is to be inputted, such as for example a location name of a navigation target can be inputted by spelling. A correction within a running speech inputting is not provided. If a correction of inputting information must be performed, this can be done only after the end of the inputting procedure by repeating the speech input for the desired information. This method can be considered to be quite complicated, and can significantly distract the driver of a motor vehicle from traffic actions.

### SUMMARY OF THE INVENTION

Accordingly, it is an object of the present invention to provide a method for speech controlling of an electrical device, which eliminates the disadvantages of the prior art.

The inventive method for speech control of an electrical device, in which the informations to be inputted are inputted by spelling and in which a detected character or a detected character sequence is outputted for acknowledgment of the character input, has the advantage that after the input of a character the user receives an information about the character which is actually recognized by the device or the actual recognized character sequence. This provides for a possibility of an immediate correction of the input in the case of a falsely recognized speech input. A complicated complete repeating of the speech input is therefore avoided.

By the outputting of the signs before the next input, advantageously an interactive operation with the electrical device is provided, so that the input and recognition error are excluded early and thereby the input is simplified.

In accordance with the present invention, it is preferable when an acoustic and/or optical output is provided. Thereby a simple control of the input is possible.

Furthermore, it is advantageous when for correction of a not correctly recognized character or not correctly recognized character sequence, the previously inputted characters or the previously inputted character sequence is again inputtable. For this purpose advantageously a correction command in form of a speech input is inputted, which acts for an erasing of the previously inputted characters or the previously inputted character sequence.

For acceleration of the speech input procedure it is further advantageous when in accordance with a further embodiment of the present invention, during determination of correspondence of a sequence of individual inputted characters with a stored information or at the beginning of a stored information, the stored information is inputted as an input proposal. It is especially advantageous to provide a possibility of taking over an outputted input proposal by speech input of a confirmation command at a desired input.

Furthermore, in accordance with a preferable embodiment of the invention, an input proposal by speech input of a further character or a further character sequence is rejected. After the speech input of a further character, then advantageously the previously rejected input proposal is no longer considered as an input proposal, when the then inputted characters are contained in the rejected input proposal. Thus, the possibility is provided for generation of further, deviating input proposals, which make possible a further acceleration of the input procedure.

It is especially advantageous when the speech input for a navigation system is provided. This type of input is simple and easily learnable and a driver does not distract from traffic actions.

In particular, with the present invention, the target and/route input are significantly simplified. Also, they are performed in a reliable and fast manner.

An especially simple distinguishable feature for the electrical device is the input of individual characters for the purpose of a character sequence for a command. Thereby the electric device can engage the proper storage and find the searched answer.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a block diagram of a part of an electrical device which is important for the invention, for performing an inventive method; and

FIG. 2 is a view showing a flow chart of a preferable embodiment of the inventive method of speech inputting.

### DESCRIPTION OF THE PREFERRED EMBODIMENTS

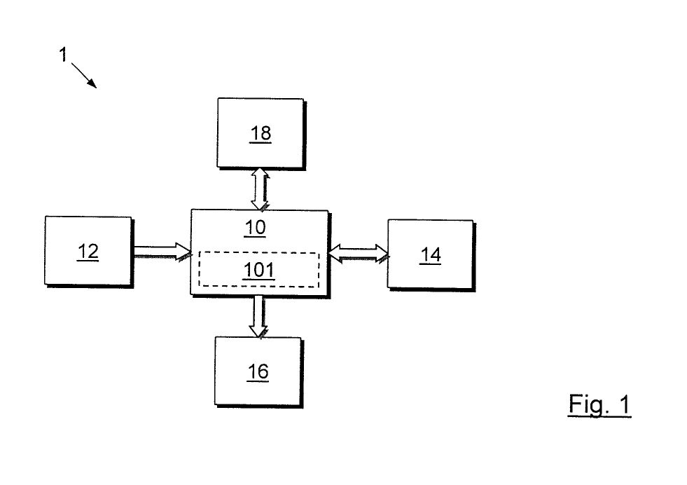

FIG. 1 shows a block diagram of an electrical device for performing a method in accordance with the present invention.

The electrical device which is to be controlled by speech inputting is provided with a microphone 12 for receiving spoken informations. The output signals of the microphone 12 are supplied to a control 10. The control 10 is formed preferably as a program-controlled microprocessor. By controlling of corresponding functions for realization of the operational course and operations of the device, operational programs can be processed in the microprocessor as components of the control.

A storage 14 is connected with the control 10. In the storage a speech data and the elements of a speech pattern associated with the speech data are stored. The speech data include in this case 26 characters of the German alphabet including three umlauts, such as Ä, Ö, and Ü, further the numerals 0 to 9, and the command words “BACK” and “INPUT”. At least one speech pattern is associated in the storage 14 with each element of the speech data, namely the characters, the umlauts, the numerals and the command words. In the case of several conventional pronunciations of one element of the speech data, such as for example the number 2 which can be pronounced in German as “ZWEI” and “ZWO”, all used speech patterns are preferably associated with a corresponding elements of the speech data in the storage 14.

For comparing a speech signal received through the microphone 12 with the speech patterns stored in the storage 14, the control 10 is provided with a comparison unit 101, which preferably can be a part of the operational program of the device in form of software. The comparison unit 101 determines, from the quantity of the speech patterns stored in the storage 14, a speech pattern which has the greatest coincidence with the received signal. If the value of the determined coincidence is over an average value, the characters, umlauts, numerals or commands associated with the determined speech pattern are recognized as correct. If the value of the determined coincidence between the received speech signal and similar speech pattern is above an average value, it is decided that the received speech signal does not correspond to any of the stored speech patterns and therefore does not represent any valid input.

An output unit 16 is finally connected with the control 10 for indication and/or acoustic outputting of one or several characters, umlauts, numerals or commands received by the microphone 12. If the comparison unit 101 determines the coincidence of a speech input with a stored speech pattern, then one or several associated characters, umlauts, numerals or commands are outputted for acknowledgment of the speech input via the output unit, or in another words indicated and/or acoustically outputted.

In accordance with a preferable embodiment of the invention, instead of a speech input up to the above mentioned command of only individual characters, additionally also a speech input of character sequences of for example two characters is provided. For this purpose the control 10 is designed so that, after a speech input of one or a first character, umlaut, or numeral, an acknowledgment of the known speech input is performed when after the speech input a predetermined time period is exceeded. If to the contrary a further speech input is performed within the predetermined time interval, than it is logically associated with the immediately preceding speech input. The speech inputs which follow directly one after the other are verified in the above described manner by comparison of the individual inputs with stored patterns. In the case of the sufficiently high coincidence of the inputs with the next coming stored pattern they are accepted as correct inputted character- or symbol sequence, when in the storage 14 such character- or symbol sequence is stored. The inputted symbol sequence or preferably a control command represented by the inputted symbol sequence, is then complete outputted as acknowledgment through the output unit 16. If for example after the speech input of the character “A” within the predetermined time interval, the further speech input of the character “R” is performed, then both characters due to the sufficient coincidence with the corresponding stored speech patterns in the storage 14 are recognized as correct. When in the storage 14 the character sequence from the character “A” and “R” is provided as abbreviation for a control command, then through the output unit 16 the output of the control command associated with the character sequence “AR” is performed, which in this case is for example “AUTORADIO”. The control of the autoradio is activated by the character sequence “AR”.

The quantity of the symbols stored in the storage 14, namely characters, umlauts and numbers, as well as commands and character sequences is for example context-sensitive for the comparison operations allowed or locked. Such characters-or symbol sequences, which in connection with an actual control function represent no valid control commands, are excluded from comparison operations. For example with the character sequence “NA” a vehicle navigation device is inquired and subsequently by speech input of the character sequence “ZI” the input of a target location for the vehicle navigation device is started, for example the character sequence “NA” is excluded from the comparison operations as a character sequence which produces no valid control commands. In a similar way, for example during the target location input, such characters can be excluded from the comparison operations and thereby from the speech input, which in connection with the previously inputted characters provide no valid target location contained in a map base. The map base can be realized preferably in form a mass storage 18 connected with the control 10, for example as a CD-ROM introduced in a CD-ROM reading device.

As a target- route inputs all desirable locations, streets, buildings etc. of a stored street map (for example CD-ROM) can be inputted by the speech input of individual characters, symbols and numerals. Control commands to the contrary are inputted basically in a symbol sequence with at least two symbols, as explained herein above. It is also provided so that for the control command complete syllables or words can be utilized, for example “INPUT”.

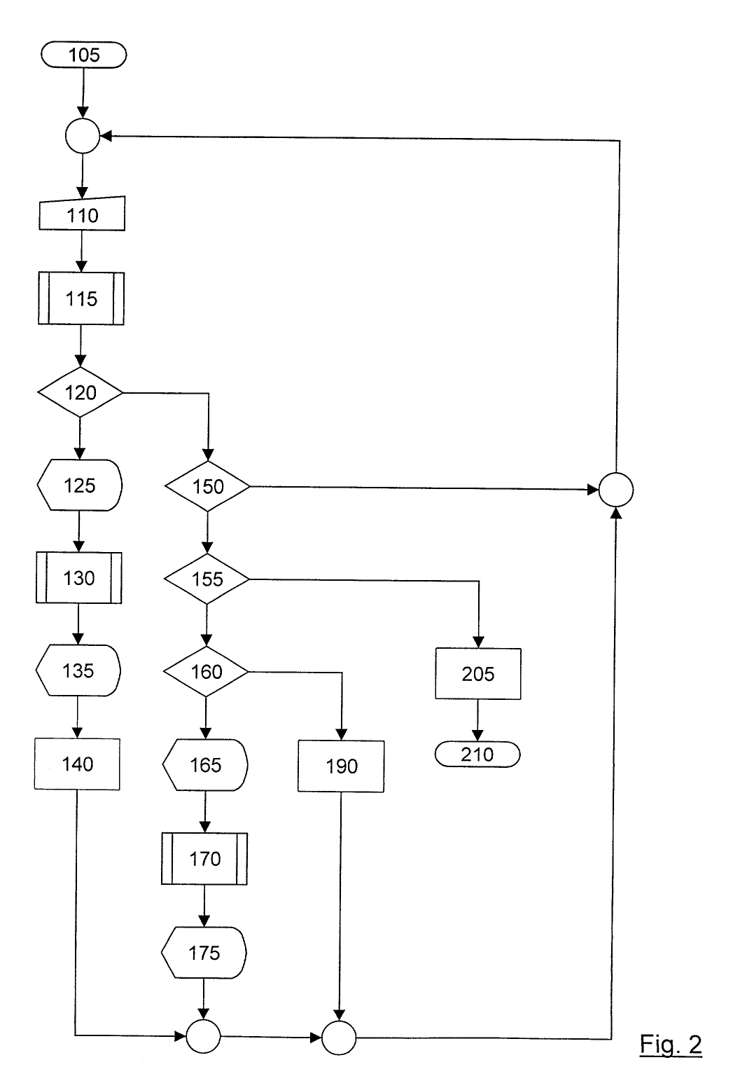

The inventive input method is illustrated by a flow chart which is substantially represented in FIG. 2.

The process starts with step 105, with turning on of the speech control device 1.

In step 110 a speech input is performed by receiving of one or several symbols spoken by the user, for example characters, umlauts and numerals, symbol sequences or commands.

If in step 120 it is determined that during the speech input it deals with symbol contained in the storage 14, it is then indicated and/or acoustically outputted in step 125 for acknowledgment of the speech input.

In step 130, in the map storage 18, after a coincidence of an inputted character or symbol or an inputted character- or symbol sequence with an input, for example target names starting with the inputted character or the inputted character sequence are searched. If such an input is detected in step 135 it is presented and/or acoustically outputted as an input proposal by the output unit 16. In step 140 in the case of the indication of the input proposal, an input cursor which marks the next position to be inputted is displaced to the position which follows the inputted characters.

If in the following input step 110 the speech input of a confirmation command, such as the word “INPUT” is performed, and if due to comparison operations performed in step 115 it is associated with a corresponding input in the storage 14, then in step 120 it is determined that during the last speech input it does not deal with a character and subsequently in step 150 it is determined that a speech input represents a speech sequence. In step 155 this character sequence is recognized as a confirmatioon command “INPUT”, and therefore in step 205 the offered input proposal is taken over as an input. The process ends in step 210 after the conclusion of the speech input.

If in step 110, instead of the speech input of the confirmation command, an input of correction command namely for example the instruction BACK is performed, and if in step 115 in the storage 14 a correction command is associated, then in step 120 it is determined that during the actual inputting it does not deal with a character- or symbol input. In step 150 is then determined that the actual input is a character sequence. In step 155 it is determined that the character sequence is not a confirmation command, and in step 160 it is determined that the character sequence is a correction command. Because of the input of a correction command, in step 190 the previously performed input, for example the previously inputted character is, during indication of the input the input curser is placed at the previously inputted character or symbol, and the input procedure is advanced with a new speech input in step 110.

If in step 110 a speech input is performed, which due to unclear pronunciation, external disturbance noise or the fact that this input is context sensitive excluded, has no or an unsufficient coincidence with the speech pattern stored in the storage, then in step 120 it is determined that during the actual input it deals with no valid symbol- or character sequence. In step 150 it is determined that during the actual input also no valid character- or symbol sequence takes place. The input is then ignored and the process proceeds with the further input in step 110.

If for example in step 110 a speech input of a symbol- or character sequence is performed, whose individual symbols or characters are clearly associated in step 115 with speech patterns, and which together with an abbreviation in the storage 14 correspond to a control command, then in step 120 it is determined that during the actual input it deals not with an individual character or an individual symbol. In step 150 it is determined that the valid character- or symbol sequence is provided. In steps 155 and 160 it is determined that the actual input does not correspond either to a confirmation command or a correction command. Then in step 165 the recognixed character sequence is indicated as an acknowledgment and/or acoustically outputted. In step 170 the control command corresponding to the character- or symbol sequence is read and in step 175 outputted as an input offer , which is taken by producing a confirmation command in the following input step 110 or can be declined by input of a correction command in step 110.

If in a previous input step 110 a character or symbol is introduced and therefore an entry from the mass storage is outputted as an input proposal, then it is rejected by a new character- or symbol input and is marked in the mass storage as not to be considered for following comparison operations. Because of the new character input, then a new input proposal is outputted.

The inventive process is illustrated as an example for a target location input in a vehicle navigation system.

Step 105: start of the speech input

Step 110: speech input of character “S”

Step 115: comparison of the input with storage contents

Step 120: character “S” is recognized

Step 125: output of character “S”

Step 130: determination of the coincidence “SAARBRÜCKEN”

Step 135: output of the coincidence “SAARBRÜCKEN”

Step 130: input curser is further moved to a position

Step 110: speech input of character “A”

Step 115: comparison of the input with storage content

Step 120: character “A” is recognized

Step 125: output of character “A”

Step 130: determination of coincidence “SAARBURG”, coincidence “SAARBRÜCKEN” is no longer considered since due to a further character input it is rejected.

Step 135: output of the coincidence “SAARBURG”

Step 140: input curser is moved further to a position.

Step 110: speech input of character “A”

Step 115: comparison of the input with storage contents

Step 120: character “A” is interpreted due to clear pronunciations or because interference noise as “H”

Step 125: output of character “H”

Step 130: determination of no coincidence with initial characters

Step 135: output of no coincidence

Step 110: input “BACK!”

Step 115: comparison of the input with storage contents

Step 120: input is not a character

Step 150: input is character sequence

Step 155: input is not confirmation

Step 160: input is correction command

Step 190: input curser is moved back to previously inputted character “H”

Step 110: speech input of character “A”

Step 115: comparison of the input with storage contents

Step 120: character “H” is not understood due to unclear pronunciation or because of interference noises

Step 150: understood input is not character sequence

Step 110: speech input of character “A”

Step 120: character “A” is recognized

Step 125: output of character “A”

Step 130: determination of the coincidence “SAARHÖLZBACHG”

Step 135: output of the coincidence “SMRHÖLZBACHG”

Step 140: input curser is moved further to a position?

Step 110: speech input of character “R”

Step 115: comparison of the input with storage contents

Step 120: character “R” is interpreted because of unclear pronunciation because of interference noises as a character sequence “AR”

Step 150: understood input is a character sequence “AR”

Step 155: character sequence “AR” is no confirmation

Step 160: character sequence “AR” is no correction command

Step 165: understood character sequence “AR” is outputted

Step 170: determination of the coincidence “AUTORADIO”

Step 175: output of the coincidence “AUTORADIO”

Step 110: is “BACK!”

Step 115: comparison of the input with storage contents

Step 120: input with no character

Step 150: input with no character sequence

Step 155: input with no confirmation

Step 160: input is correction command

Step 190: coincidence of “AUTORADIO” is rejected. The input curser is replaced to the position behind the previously inputted characters.

Step 110: speech input of character “R”

Step 120: character “R” is recognized

Step 125: output of character “R”

Step 130: determination of the coincidence “SAARLOUIS”

Step 135: output of the coincidence “SAARLOUIS”

Step 140: input curser is moved further to a position

Step 110: speech input “INPUT!”

Step 115: comparison of the input with storage contents

Step 120: input with no character

Step 150: input is character sequence

Step 155: input is confirmation

Step 205: offered coincidence is taken over

Step 210: end of the speech input.

It will be understood that each of the elements described above, or two or more together, may also find a useful application in other types of methods differing from the types described above.

While the invention has been illustrated and described as embodied in method for speech control of an electrical device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for speech control of an electrical device, comprising the steps of acoustically inputting information by spelling in an electrical device; and outputting by the electrical device a recognized character or a recognized symbol or a recognized character- or symbol sequence for acknowledgment of the character- or symbol input.

2. A method as defined in claim 1; and further comprising the output of the known character or symbol before a next input.

3. A method as defined in claim 1; and further comprising the output of the known character or symbol acoustically.

4. A method as defined in claim 1; and further comprising the output of the known character or symbol optically.

5. A method as defined in claim 1; and further comprising the output of the known character or symbol acoustically and optically.

6. A method as defined in claim 1; and further comprising providing a correction of a not correctly recognized character or symbol or a not correctly recognized character- or symbol sequence of previously inputted characters or previously inputted symbols or previously inputted character- or symbol sequence correspondingly.

7. A method as defined in claim 6, wherein said correcting includes again acoustically inputting of the previously inputted character or the previously inputted symbol of the previously inputted character- or symbol sequence.

8. A method as defined in claim 1; and further comprising outputting a stored information as an input proposal.

9. A method as defined in claim 8; and further comprising performing said outputting of the stored information during a determination of a coincidence of a sequence of individual inputted characters or symbols with the stored information.

10. A method as defined in claim 8; and further comprising performing said outputting of the stored information at a beginning of a stored information.

11. A method as defined in claim 8; and further comprising receiving the input proposal by a speech input of a confirmation command.

12. A method as defined in claim 8; and further comprising rejecting of the input proposal by a speech input of a further character or symbol or a further character-space or symbol sequence.

13. A method as defined in claim 1; and further comprising using a navigation system of a motor vehicle as the electrical device.

14. A method as defined in claim 13; and further comprising using for the informations to be inputted an information selected from the group consisting of a target command, a route input, and a control command.

15. A method as defined in claim 12; and further comprising inputting target- and route input in individual characters and control commands as symbol sequences with at least two symbols.

16. A method as defined in claim 14; and further comprising using the inputted symbols during the symbol input of control commands as initial characters of a word.
